(19) United States
(12) Patent Application Publication
(10) Pub. No.: US 2024/0234848 A1
(43) Pub. Date: Jul. 11, 2024

(54) METHOD FOR TREATING SECONDARY BATTERY

(71) Applicant: HONDA MOTOR CO., LTD., Tokyo (JP)

(72) Inventors: Yushi FUJINAGA, Saitama (JP); Hideki MATSUDA, Saitama (JP); Mitsumasa SORAZAWA, Saitama (JP); Takayuki SAKATA, Saitama (JP); Ryo SHIMIZU, Saitama (JP)

(21) Appl. No.: 18/407,476

(22) Filed: Jan. 9, 2024

(30) Foreign Application Priority Data
Jan. 11, 2023 (JP) 2023-002593

(51) Int. Cl. H01M 10/54; C22B 1/00; C22B 7/00; C22B 26/12

(52) U.S. Cl. CPC H01M 10/54; C22B 1/005; C22B 7/006; C22B 26/12

(57) ABSTRACT

A method for treating a secondary battery that can recover materials constituting the secondary battery safely and efficiently and contributes to energy efficiency. The method for treating a secondary battery containing metallic lithium in a negative electrode includes bringing water vapor at 40° C. to 175° C. into contact with a battery cell.

This application is based on and claims the benefit of priority from Japanese Patent Application No. 2023-002593, filed on 11 Jan. 2023, the content of which is incorporated herein by reference.

### BACKGROUND OF THE INVENTION

### Field of the Invention

The present invention relates to a method for treating a secondary battery.

### Related Art

In recent years, research and development have been conducted on secondary batteries that contribute to energy efficiency in order to ensure that more people have access to affordable, reliable, sustainable, and advanced energy.

As a secondary battery, a secondary battery in which metallic lithium is used as a negative electrode is known. Since such a secondary battery contains many valuables such as metallic lithium, it is preferable to recover and reuse valuables from used secondary batteries. However, when recycling the secondary battery containing metallic lithium, it is highly risky to decompose the battery cell in a state where metallic lithium having high reactivity remains inside the battery cell. Accordingly, technology has been proposed to deactivate metallic lithium remaining in a battery cell to lower reactivity (for example, see Patent Documents 1 to 3).

Patent Document 1: Japanese Unexamined Patent Application, Publication No. H06-338353

Patent Document 2: Japanese Patent No.7109702

Patent Document 3: PCT International Publication No. WO2021/201055

### SUMMARY OF THE INVENTION

Patent Document 1 discloses technology of supplying a substance reactive to a negative electrode active material for the purpose of safely disassembling a used lithium battery. However, the above technology requires disassembling the battery under an atmosphere of a dry inert gas or the like, and requires labor and cost for disassembling the battery. Patent Document 1 does not refer to conditions suitable for the supply of the reactive substance except that the concentration of hydrogen gas in the treatment is set to be equal to or lower than the explosion limit value.

Patent Document 2 discloses technology including a first heat treatment step and a second heat treatment step of heating battery waste in an atmosphere containing a greater amount of oxygen than the first heat treatment step as a method for treating the battery waste. Patent Document 3 discloses, as a method for heat-treating battery waste containing lithium, a heat-treating method of heating the battery waste while adjusting the oxygen partial pressure in a furnace.

The technology disclosed in Patent Document 2 sets the maximum attainable temperature of battery waste to 400° C. to 800° C., and the technology disclosed in Patent Document 3 sets the maximum attainable temperature of battery waste to 500° C. to 650° C. However, in any of the above temperature ranges, there is an issue that a reaction between molten metallic lithium and valuables other than metallic lithium occurs, so that these valuables cannot be efficiently recovered. Furthermore, there is an issue that energy consumption and CO emission are increased by performing the treatment at a high temperature.

In response to the above issues, an object of the present invention is to provide a method for treating a secondary battery that can recover materials constituting a secondary battery safely and efficiently and contributes to energy efficiency.

(1) A first aspect of the present invention relates to a method for treating a secondary battery containing metallic lithium in a negative electrode. The method includes bringing water vapor at 40° C. to 175° C. into contact with a battery cell.

According to the invention of the first aspect, it is possible to provide a method for treating a secondary battery that can recover materials constituting the secondary battery safely and efficiently and contributes to energy efficiency.

(2) In a second aspect of the preset invention according to the first aspect, a relative humidity of gas that contacts the battery cell in bringing the water vapor into contact with the battery cell is 40% or more.

According to the invention of the second aspect, it is possible to treat the secondary battery more efficiently and with lower energy.

(3) In a third aspect of the present invention according to the first or second aspect, bringing the water vapor at 40° C. to 175° C. into contact with the battery cell comprises bringing the water vapor at 40° C. to 70° C. into contact with the battery cell.

According to the invention of the third aspect, it is possible to treat the secondary battery with lower energy.

(4) In a fourth aspect of the present invention according to any one of the first to third aspects, the method further includes, after bringing the water vapor into contact with the battery cell, dissolving, in water, a battery cell constituent material containing the metallic lithium deactivated and recovering the battery cell constituent material.

According to the invention of the fourth aspect, it is possible to more safely recover the material constituting the battery cell and treat the secondary battery.

(5) In a fifth aspect of the present invention according to any one of the first to fourth aspects, the method does not include roasting the battery cell.

According to the invention of the fifth aspect, by treating the secondary battery without roasting the battery cell, it is possible to treat the secondary battery more safely and with lower energy.

### BRIEF DESCRIPTION OF THE DRAWINGS

FIG. 1 is a flowchart showing a method for treating a secondary battery according to the present embodiment;

FIG. 2 is a conceptual sectional view showing the configuration of a secondary battery cell according to the present embodiment;

FIG. 3 is a graph showing a relationship between the conditions of the gas brought into contact with a negative electrode and the Li reaction rate;

FIG. 4 is a graph showing a relationship between the conditions of the gas brought into contact with a battery cell and the Li reaction rate; and

FIG. 5 is a graph showing a relationship between the amount of water vapor brought into contact with the battery cell and the deactivation time.

### DETAILED DESCRIPTION OF THE INVENTION

### Overview of Method for Treating Secondary Battery

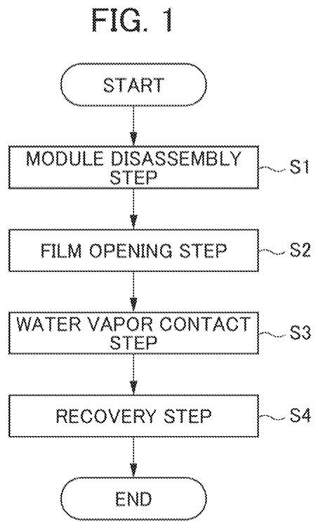

The method for treating a secondary battery according to the present embodiment is a method of deactivating metallic lithium (Li) of a secondary battery containing metallic lithium (Li) in the negative electrode. The method for treating a secondary battery according to the present embodiment includes a water vapor contact step S3 shown in FIG. 1. The water vapor contact step S3 is a step of bringing water vapor at 40° C. to 175° C. into contact with the battery cell.

Examples of the target of the method for treating a secondary battery according to the present embodiment include a solid-state secondary battery including a solid electrolyte. Hereinafter, the secondary battery that is the target of the method for treating a secondary battery according to the present embodiment will be described as a solid-state secondary battery. On the other hand, the secondary battery is not limited to a solid-state secondary battery, and may be, for example, a battery using an electrolytic solution as an electrolyte, or a polymer battery in which an electrolytic solution is contained in a polymer gel.

### Solid-State Secondary Battery

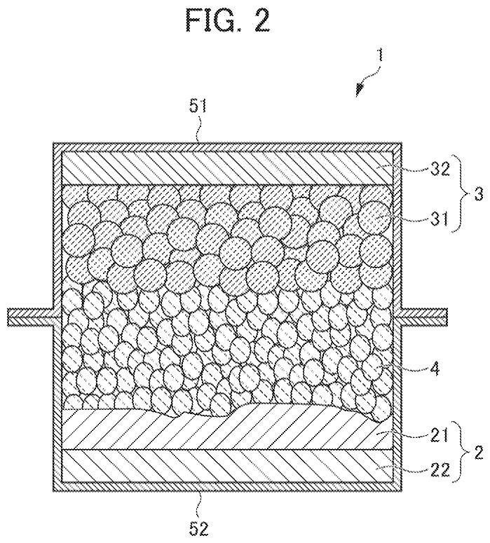

FIG. 2 is a sectional view showing an outline of the configuration of a solid-state secondary battery included in the target of the method for treating a secondary battery according to the present embodiment. As shown in FIG. 2, a battery cell 1 of the solid-state secondary battery includes: a negative electrode 2 including a negative electrode active material 21 and a negative electrode current collector 22; a positive electrode 3 including a positive electrode active material 31 and a positive electrode current collector 32; a solid electrolyte layer 4 stacked between the negative electrode 2 and the positive electrode 3; and exterior bodies 51 and 52 for housing a stack including the negative electrode 2, the solid electrolyte layer 4, and the positive electrode 3.

### Negative Electrode Layer

The negative electrode 2 includes, for example, the negative electrode current collector 22 and the negative electrode active material 21 stacked on the negative electrode current collector 22. In addition to the above, the negative electrode 2 may include a binder, a conductivity aid, an electrolyte, and the like. The binder, the conductivity aid, the electrolyte, and the like are not limited, and substances known as electrode materials for secondary batteries can be applied.

The negative electrode active material 21 contains lithium metal as an essential component. The negative electrode active material 21 may contain another negative electrode active material in addition to the lithium metal. Examples of the negative electrode active material in addition to the lithium metal include lithium transition metal oxides such as lithium titanate (Li₄Ti₅O₁₂), transition metal oxides such as TiO₂, Nb₂O₃, and WO₃, metal sulfides, metal nitrides, carbon materials such as graphite, soft carbon, and hard carbon, metallic indium, and lithium alloys.

The negative electrode current collector 22 is not limited, and a substance known as a negative electrode current collector for solid-state secondary batteries can be used. The negative electrode current collector preferably contains at least one selected from the group consisting of copper metal, stainless steel, and aluminum, and more preferably contains copper metal. This is because the method for treating a secondary battery according to the present embodiment can preferably recover copper metal in a solid-state secondary battery containing copper metal as a negative electrode current collector.

### Positive Electrode Layer

The positive electrode 3 includes, for example, the positive electrode current collector 32 and the positive electrode active material 31 stacked on the positive electrode current collector 32. In addition to the above, the positive electrode 3 may include a binder, a conductivity aid, an electrolyte, and the like. The binder, the conductivity aid, the electrolyte, and the like are not limited, and substances known as electrode materials for secondary batteries can be applied.

The positive electrode active material 31 is not limited, and a substance known as a positive electrode active material for secondary batteries can be used. Examples of the positive electrode active material include ternary positive electrode materials such as LiCoO₂, LiNiO₂, and NCM (Li(NiₓCo_{y}Mn_{z})O₂, (0<x<1, 0<y<1, 0<z<1, x+y+z=1)), layered positive electrode active material particles such as LiVO₂ and LiCrO₂, spinel positive electrode active materials such as LiMn₂O₄, Li(Ni_{0.25}Mn_{0.75})₂O₄, LiCoMnO₄, and Li₂NiMn₃O₈, and olivine positive electrode active materials such as LiCoPO₄, LiMnPO₄, and LiFePO₄.

The positive electrode current collector 32 is not limited, and a substance known as a positive electrode current collector for solid-state secondary batteries can be used. Examples of the positive electrode current collector 32 include metal foils such as stainless steel (SUS) foil and aluminum (Al) foil.

### Solid Electrolyte Layer

The solid electrolyte layer 4 contains a solid electrolyte as an essential component. The solid electrolyte is not limited, and examples thereof include sulfide-based solid electrolytes, oxide-based solid electrolytes, nitride-based solid electrolytes, halide-based solid electrolytes, and the like. Among them, it is preferable to use a sulfide-based solid electrolyte as the solid electrolyte. This is because the method for treating a secondary battery according to the present embodiment can control the generation of hydrogen sulfide that can be generated during treatment of the secondary battery even when a sulfide-based solid electrolyte is used as the solid electrolyte. Examples of the sulfide-based solid electrolyte include LPS-based halogen (Cl, Br, I), Li₂S—P₂S₅, Li₂S—P₂S₅—LiI, and the like. The above “Li₂S—P₂S₅” means a sulfide-based solid electrolyte material including a raw material composition containing Li₂S and P₂S₅.

### Exterior Bodies

The exterior bodies 51 and 52 house the stacked negative electrode 2, electrolyte layer 4, and positive electrode 3. As shown in FIG. 2, for example, a pair of laminated films can be used as the exterior bodies 51 and 52. The feature of the exterior bodies is not limited to the above, and known exterior bodies applied to secondary batteries can be used.

### Method for Treating Secondary Battery

The method for treating a secondary battery according to the present embodiment essentially includes the water vapor contact step S3 shown in FIG. 1. As shown in FIG. 1, the method for treating a secondary battery according to the present embodiment preferably includes a module disassembly step S1, a film opening step S2, a water vapor contact step S3, and a recovery step S4 in this sequence.

### Module Disassembly Step S1

The module disassembly step S1 is a step of disassembling a battery module including a plurality of battery cells into a plurality of battery cells and module constituent members. The module constituent members are not limited, and examples thereof include a bus bar, a voltage detection line, a thermistor, a binding bar, an end plate, a separator, a harness, a battery case, a battery case fixing member, and a cell voltage/temperature monitor unit. Since the method for treating a secondary battery according to the present embodiment includes the module disassembly step S1, the time required for deactivation can be reduced.

On the other hand, the method for treating a secondary battery according to the present embodiment may not include the module disassembly step S1. This reduces the danger associated with the work in the module disassembly step S1.

### Film Opening Step S2

The film opening step S2 is a step of opening at least a part of the exterior bodies 51 and 52 of the battery cell 1. The above-mentioned opening means changing a state where the stack is sealed by the exterior bodies 51 and 52 to a state where gas containing water vapor can flow into the interior of the exterior bodies 51 and 52, and there is no need to completely separate the exterior bodies 51 and 52. The opening method is not limited, and joints of the exterior bodies 51 and 52 maybe peeled off, or holes may be made at any positions of the exterior bodies 51 and 52.

### Water Vapor Contact Step S3

The water vapor contact step S3 is a step of bringing water vapor at 40° C. to 175° C. into contact with the battery cell 1 and thereby deactivating metallic lithium contained in the battery cell 1. By bringing the metallic lithium into contact with the water vapor, the metallic lithium reacts with water to form lithium hydroxide. By the progress of the reaction, the reactivity of lithium can be reduced (deactivated).

Since the temperature of the water vapor that contacts the battery cell 1 in the water vapor contact step S3 is 40° C. to 175° C., and the temperature range is lower than the melting point (about 180° C.) of the metallic lithium, the water vapor contact step S3 can deactivate the metallic lithium without melting it. If the metallic lithium is melted, the positive electrode active material (for example, NCM) may react with the melted metallic lithium. In this case, since the costly positive electrode active material cannot be recovered in a state in which the molecular structure is maintained, the recovery efficiency of the positive electrode active material decreases. The water vapor contact step S3 according to the present embodiment can improve the recovery efficiency of the positive electrode active material for the above reasons.

The relative humidity of the gas (air) containing water vapor that contacts the battery cell 1 in the water vapor contact step S3 is preferably 40% or more. From the viewpoint of energy efficiency, the temperature of the water vapor in the water vapor contact step S3 is preferably as low as possible. However, since the amount of saturated water vapor decreases as the temperature decreases, the amount of water vapor necessary for efficient deactivation of metallic lithium may not be ensured. On the other hand, from the viewpoint of shortening the treatment time, the temperature of the water vapor in the water vapor contact step S3 is preferably as high as possible. By setting the relative humidity of the gas in the water vapor contact step S3 to 40% or more, for example, even when the temperature of the gas containing water vapor is lower than 90° C. or 70° C. or lower, the battery cell 1 can be efficiently deactivated from the viewpoint of energy efficiency and it is also preferable from the viewpoint of treatment time. From the viewpoint of only treatment time, the temperature of the water vapor may be 90° C. to 175° C.

The amount of water vapor (g/m³) that contacts the battery cell 1 in the water vapor contact step S3 is calculated by the following Equation (1). The amount of water vapor can be set from the viewpoint of energy efficiency and treatment time described above. The amount of water vapor may be set as a threshold for suppressing deterioration of the materials constituting the battery cell 1. This makes it possible to set an optimum amount of water vapor in consideration of the deactivation speed of metallic lithium and suppression of deterioration of the materials. Amount of water vapor (g/m³)=Amount of saturated water vapor (g/m³) at a predetermined temperature×relative humidity (%) at the predetermined temperature (1)

### Recovery Step S4

The recovery step S4 is a step of immersing the battery cell 1 (battery cell constituent materials) after the water vapor contact step S3 in water. By the recovery step S4, water-soluble substances such as lithium hydroxide and sulfide-based solid electrolyte generated in the water vapor contact step S3 and water-insoluble substances such as the negative electrode current collector 22 and the positive electrode active material 31 can be separated. Furthermore, by controlling the amount of gas generated in the water vapor contact step S3, the amount of gas generated in the recovery step S4 can be reduced.

The recovery step S4 includes a step of recovering a positive electrode material such as a positive electrode active material (e.g., NCM) that is a water-insoluble substance. In the recovery step S4, the positive electrode active material (e.g., NCM) can be recovered with little damage. The recovered positive electrode active material may be subjected to a treatment such as re-addition of lithium or structure repair as appropriate, depending on the recovered state. The negative electrode current collector 22 (e.g., copper foil) or the like, which is a water-insoluble substance other than the positive electrode active material, may be recovered at the same timing as this step. The recovery step S4 may include a step of recovering only lithium from an aqueous solution containing lithium or the like generated. The recovery step S4 may further include a step of separating and recovering other components from the solution after lithium is recovered.

The method for treating a secondary battery according to the present embodiment may include any other step as long as the effect of the present invention is not impaired. For example, a determination step of determining whether metallic lithium contained in the battery cell 1 has been deactivated may be provided between the water vapor contact step S3 and the recovery step S4. In the determination step, for example, the voltage of the battery cell may be monitored and the state in which the voltage falls below a predetermined threshold may be determined as the metal lithium being deactivated.

On the other hand, the method for treating a secondary battery according to the present embodiment preferably does not include a roasting step of roasting the battery cell 1 throughout all the steps. By not including the roasting step, energy required for the treatment and generation of CO can be reduced.

The preferred embodiment of the present invention has been described above. The present invention is not limited to the above embodiment, and modifications and improvements are included in the present invention to the extent that the object of the present invention can be achieved.

### EXAMPLES

Next, an Example of the present invention will be described, but the present invention is not limited to this Example.

### Deactivation Gas Contact Test for Negative Electrode

FIG. 3 is a graph showing a relationship between the reaction time (hr) and the Li reaction rate (%) when water vapor (H₂O) as a deactivation gas was brought into contact with a negative electrode (the negative electrode 2 including the negative electrode current collector 22: copper foil, and the negative electrode active material 21: metallic lithium in FIG. 2) under the conditions (temperature and relative humidity) shown in FIG. 3. The Li reaction rate (%) is calculated by the following Equation (2). Li reaction rate (%)=Amount of Li hydroxide after deactivation treatment/Amount of metal Li before deactivation treatment×100 (2)

With respect to the amount of Li hydroxide and the amount of metallic Li in the above Equation (2), after the observed site was processed by focused ion beams (FIB), the Li reaction rate was measured by energy dispersive X-ray spectroscopy (SEM-EDX) using an electron microscope. A Focused Ion and Electron Beam System Ethos NX5000 (manufactured by Hitachi High-Tech Corporation) was used for the measurement.

### Deactivation Gas Contact Test for Battery Cell

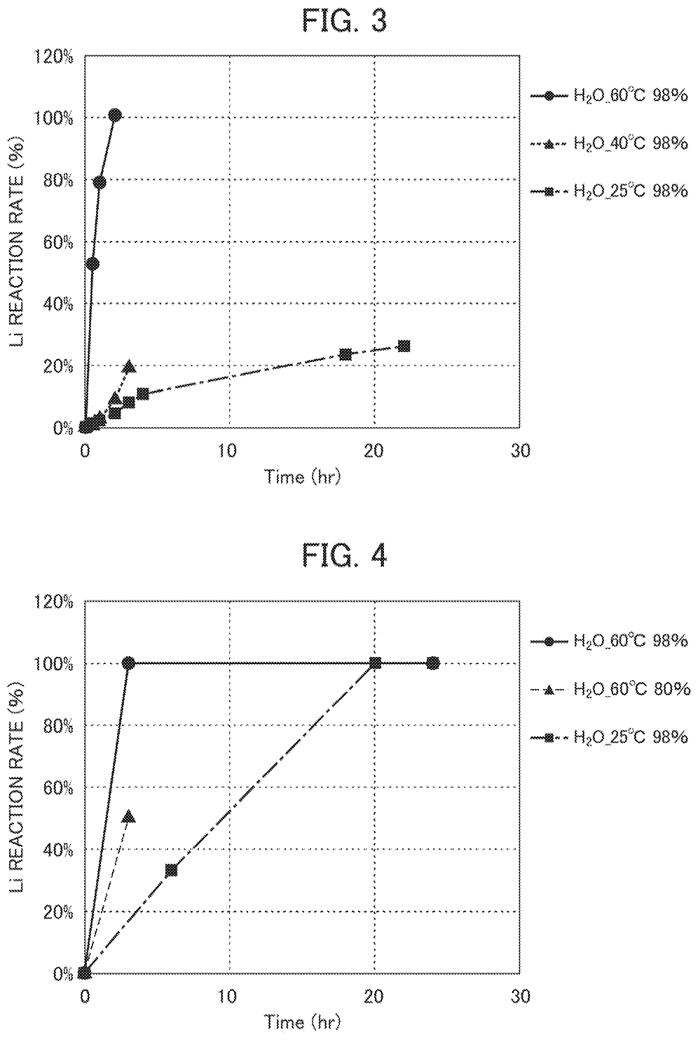

FIG. 4 is a graph showing a relationship between the reaction time (hr) and the Li reaction rate (%) when a part of exterior bodies was opened and water vapor (H₂O) as a deactivation gas was brought into contact with a battery cell (the battery cell 1 including the negative electrode current collector 22: copper foil, the negative electrode active material 21:

metallic lithium, the solid electrolyte layer 4: sulfide-based solid electrolyte, the positive electrode active material 31: NCM (Li(NiₓCo_{y}Mn₂)O₂), and the positive electrode current collector 32: aluminum foil in FIG. 2) under the conditions (temperature and relative humidity) shown in FIG. 4. That is, FIG. 4 corresponds to the water vapor contact step S3 in the above embodiment.

From the results shown in FIG. 4, in the case of deactivating metallic lithium contained in the battery cell, when water vapor (H₂O) is used as the deactivation gas, it is clear that the greater the amount of water vapor (g/m³), the shorter the time required for deactivation of Li, and the deactivation speed can be controlled by the amount of water vapor (g/m³). The method of calculating the amount of water vapor (g/m³) is as described above.

### Setting of Amount of Water Vapor (Deactivation Condition)

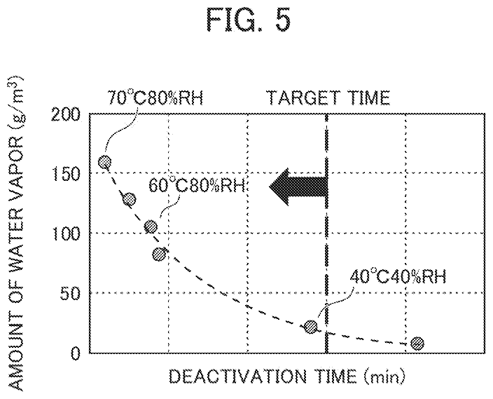

FIG. 5 is a graph showing a relationship between the deactivation time (min) and the amount of water vapor (g/m³) when the time taken for the metal Li from an end part to the central part of the cell to react with the water vapor is defined as the deactivation time.

In the graph of FIG. 5, the greater the amount of water vapor, the shorter the deactivation time. Therefore, for example, a target time is set from the viewpoint of shortening the treatment time and from the viewpoint of energy efficiency, and the conditions of the amount of water vapor (g/m³) can be determined under the conditions equal to or less than the target time.

### EXPLANATION OF REFERENCE NUMERALS

1 battery cell
2 negative electrode
21 negative electrode active material (metallic lithium)
S3 water vapor contact step
S4 recovery step

What is claimed is:

1. A method for treating a secondary battery containing metallic lithium in a negative electrode, the method comprising:
bringing water vapor at 40° C. to 175° C. into contact with a battery cell.

2. The method for treating a secondary battery according to claim 1, wherein a relative humidity of gas that contacts the battery cell in bringing the water vapor into contact with the battery cell is 40% or more.

3. The method for treating a secondary battery according to claim 1, wherein bringing the water vapor at 40° C. to 175° C. into contact with the battery cell comprises bringing the water vapor at 40° C. to 70° C. into contact with the battery cell.

4. The method for treating a secondary battery according to claim 1, further comprising, after bringing the water vapor into contact with the battery cell, dissolving, in water, a battery cell constituent material containing the metallic lithium deactivated and recovering the battery cell constituent material.

5. The method for treating a secondary battery according to claim 1, not comprising roasting the battery cell.
